(19) United States
(12) Patent Application Publication
(10) Pub. No.: US 2016/0261030 A1
(43) Pub. Date: Sep. 8, 2016

(54) ANTENNA DEVICE OF BASE STATION

(71) Applicant: KMW Inc., Hwaseong (KR)

(72) Inventors: Duk-Yong Kim, Hwaseong (KR); Young-Chan Moon, Hwaseong (KR); Chang-Woo Yoo, Hwaseong (KR); Min-Sik Park, Hwaseong (KR); Jeong-Min Kim, Yongin (KR); Hyoung-Seok Yang, Hwaseong (KR); In-Ho Kim, Yongin (KR)

(21) Appl. No.: 15/156,812

(22) Filed: May 17, 2016

Related U.S. Application Data
(63) Continuation of application No. PCT/KR2014/010815, filed on Nov. 11, 2014.

(30) Foreign Application Priority Data
Nov. 18, 2013 (KR) 10-2013-0140014

(51) Int. Cl. H01Q 1/24; H01Q 1/02; H01Q 1/12

(52) U.S. Cl. CPC H01Q 1/246; H01Q 1/1207; H01Q 1/02

(57) ABSTRACT

Various embodiments of the present invention comprise: an antenna module; and at least one RRH which is arranged to face the outer surface of the antenna module, is coupled by being directly connected to the antenna module and arranged along the longitudinal direction of the antenna module, wherein a plurality of cooling air gaps are provided between the outer surface of the antenna module and the RRH.

### CROSS REFERENCE TO RELATED APPLICATIONS

This application is a continuation of International Application No. PCT/KR2014/010815 filed on Nov. 11, 2014, which claims priorities to Korean Application No. 10-2013-0140014 filed on Nov. 18, 2013, which applications are incorporated herein by reference.

### TECHNICAL FIELD

Various embodiments of the present disclosure relate to an antenna unit for a base station, and relate to, for example, a Radio Remote Head (RRH) for receiving a signal from an antenna and a base station.

### BACKGROUND ART

In a mobile communication system, the term “base station” refers to a system for relaying radio waves of a portable terminal within a cell. The base station is mainly installed on the roof of a building to relay the radio waves of the portable terminal. Accordingly, base stations exist in units of cells and control incoming/outgoing signal transmission, traffic channel definition, and traffic channel monitoring in addition to interface functions between portable terminals and switching stations, in units of cells. An antenna unit employed in the base station is popularized due to an advantage thereof that the antenna unit has a lot of control antennas which can perform vertical or horizontal beam tilting.

As a mobile communication service is popularized, an antenna unit for providing a wireless network environment in which the service can be provided is expansively popularized, and the mobile communication service is developed from the 2G mobile communication, in which it is possible to perform only a wired call, via the 3G mobile communication to the 4G mobile communication based on the Long Term Evolution (LTE). The antenna unit for the 4G mobile communication is mounted together with the existing antenna unit for the 3G mobile communication, so as to share an installation location.

FIG. 1 is a perspective view illustrating an antenna unit for a base station according to the conventional embodiment. As illustrated in FIG. 1, an antenna unit according to the conventional embodiment has a structure in which an antenna module 10 is mounted to an to uprightly standing support 11 by fixing brackets 130 and 131, a repeater 12 is mounted at a lower side of the antenna module 10 by fixing brackets 132 and 133, and the antennal module 10 and the repeater 12 are electrically connected to each other using a plurality of cables 14. The fixing brackets 130 and 131 are arranged at upper and lower ends of the antenna module 10, respectively, to allow the antenna module 10 to be fixed to the support 11, and the fixing brackets 132 and 133 are arranged at upper and lower ends of the repeater 12, respectively, to allow the repeater 12 to be fixed to the support 11. The fixing brackets 130 to 133 serve to fix the components using fasteners, e.g., a screw, a bolt, and a nut.

However, the conventional antenna unit has a structure in which an antenna module is mounted to a support, a repeater, e.g., an RRH, is mounted therebelow, and the antenna module and the repeater are connected to each other using a cable. The arrangement of the antenna unit requires a plurality of fixing brackets and cables in order to mount the antenna module and the repeater to each other, and thus, corresponds to the reason for an increase in installation costs.

Further, in the conventional antenna unit, the antenna module and the repeater are mounted along a support, respectively, so that large costs are required for installation, maintenance, and a rental space of the antenna space, and a large mounting space is required when the antenna unit is installed, so that rental costs are increased.

Further, the conventional antenna unit has a problem in that the apparatus has a structure in which the antenna module and the repeater are electrically connected to each other using a plurality of cables so that an RF transmission loss occurs.

### SUMMARY

Various embodiments of the present disclosure are to provide an antenna unit for a base station in which components used for installing an antenna module and a repeater are minimized so that installation costs of the antenna unit is minimized and maintenance becomes easy.

Further, various embodiments of the present disclosure are to provide an antenna unit for a base station in which an installation space for the antenna unit mounted to a support is minimized, so that costs for a rental space of the antenna unit is minimized.

Further, various embodiments of the present disclosure are to provide an antenna unit for a base station in which an RF feeding loss of an antenna is minimized.

Further, various embodiments of the present invention are to provide a slim antenna unit for a base station.

Further, various embodiments of the present invention are to provide an antenna unit for a base station, which has a repeater having a structure advantageous in heat dissipation.

Further, various embodiments of the present disclosure are to provide an antenna unit for a base station, which can adjust connection states of an antenna module and an RRH from the outside.

Further, various embodiments of the present disclosure are to provide an antenna unit for a base station, which can maintain connection states of an antenna module and an RRH for a long time.

Further, various embodiments of the present disclosure are to provide an antenna unit for a base station, which can adjust connection states of an antenna module and an RRH from the outside while preventing water, moisture, and foreign substances from entering the apparatus.

In order to solve the above-described problems, an antenna unit according to various embodiments of the present disclosure is provided. The antenna unit includes: an antenna module; and one or more RRHs arranged to face the outer surface of the antenna module, directly connected and coupled to each other, and arranged along the lengthwise direction of the antenna module, wherein a plurality of cooling air gaps are provided between the outer surface of the antenna module and the RRHs.

An antenna unit for a base station according to various embodiments of the present disclosure includes: an antenna module; one or more RRHs arranged along the lengthwise direction of the antenna module to face the outer surface of the antenna module; and connection parts provided in the antenna module and the RRHs, respectively, and arranged to be hidden in the interior of the antenna unit by a connection housing, wherein the connection parts includes: one or more antenna connection parts mounted to the antenna module; one or more RRH connection parts coupled to the RRH and connected to the antenna connection parts, respectively; the connection housing formed integrally with the antenna module; one or more openings formed in the connection housing and operable from the outside; and one or more rotating operation parts arranged in the connection housing, arranged to be operable by the openings, and fixing a connection state of the connection parts.

### BRIEF DESCRIPTION OF THE DRAWINGS

FIG. 1 is a perspective view illustrating an antenna unit for a base station according to the conventional embodiment;

FIG. 2 is a perspective view illustrating an antenna unit according to a first embodiment of the present disclosure, and illustrates a state in which an RRH is coupled to an antenna module;

FIGS. 3 and 4 are perspective views illustrating an antenna unit according to the first embodiment of the present disclosure, and illustrate a state in which the antenna module and the RRH are separated from each other;

FIG. 5 is a side view illustrating an antenna unit according to the first embodiment of the present disclosure;

FIG. 6 is a perspective view illustrating the antenna unit mounted to a support according to the first embodiment of the present disclosure;

FIGS. 7A and 7B are perspective views illustrating the front surface and the rear surface of the RRH employed in the antenna unit according to the first embodiment of the present disclosure;

FIG. 8 is an exploded perspective view illustrating internal main components of the RRH employed in the antenna unit according to the first embodiment of the present disclosure;

FIG. 9 is a side view illustrating a state in which an antenna unit is mounted to a support according to a second embodiment of the present disclosure;

FIG. 10 is a perspective view illustrating a state in which the antenna unit is mounted to the support according to a second embodiment of the present disclosure;

FIG. 11 is a perspective view illustrating an antenna unit according to a third embodiment of the present disclosure, and illustrates a state in which an RRH is coupled to an antenna module;

FIGS. 12 and 13 are perspective views illustrating an antenna unit according to the third embodiment of the present disclosure, and illustrate a state in which the antenna module and the RRH are separated from each other;

FIG. 14 is a side view illustrating an antenna unit according to the third embodiment of the present disclosure;

FIG. 15 is a perspective view illustrating a state in which an antenna unit is mounted to a support according to the third embodiment of the present disclosure;

FIGS. 16A and 16B are perspective views illustrating the front surface and the rear surface of the RRH employed in the antenna unit according to the third embodiment of the present disclosure;

FIG. 17 is an exploded perspective view illustrating internal main components of the RRH employed in the antenna unit according to the third embodiment of the present disclosure;

FIG. 18 is a perspective view illustrating a state in which an antenna module and an RRH are coupled to each other by a coupling apparatus according to various embodiments of the present disclosure;

FIG. 19 is a perspective view illustrating a state in which the antenna module and the RRH are separated from each other by the coupling apparatus according to various embodiments of the present disclosure;

FIG. 20 is a perspective view illustrating a part of a connection housing according to various embodiments of the present disclosure;

FIG. 21 is a perspective view illustrating an antenna connection part arranged in the antenna module according to various embodiments of the present disclosure;

FIG. 22 is a perspective view illustrating an RRH connection part arranged in the RRH according to various embodiments of the present disclosure;

FIGS. 23 and 24 are exploded perspective views illustrating coupling apparatuses according to various embodiments of the present disclosure, respectively.

FIG. 25 is a perspective view illustrating a pair of coupling apparatuses according to various embodiments of the present disclosure;

FIG. 26 is a partially cutaway perspective view illustrating a waterproofing structure of the RRH according to various embodiments of the present disclosure; and

FIG. 27 illustrates a mounting state of the antenna connection part according to various embodiments of the present disclosure.

It should be noted that the same reference numerals are used to illustrate the same or similar components, features and configurations throughout the drawings.

### DETAILED DESCRIPTION

The following description with reference to the accompanying drawings is provided to help whole understanding of embodiments of the present disclosure as defined by the claims and the equivalents of the claims. Although the following description includes various specific details in order to help the understanding, the details will be considered to be exemplary matters Therefore, it will be understood by a person skilled in the art that variations and modifications of the embodiments described in the disclosure can be achieved without departing from the scope and spirit of the present invention. Further, the description of well-known functions and structures will be omitted for definition and simplicity. The term “substantially” may imply that it is unnecessary that cited features, parameters or values are not accurately achieved, and an allowance error, a measurement error, a measurement accuracy limit, and a deviation, a change or a feature including other components known to those skilled in the art may occur enough not to exclude an effect to be provided.

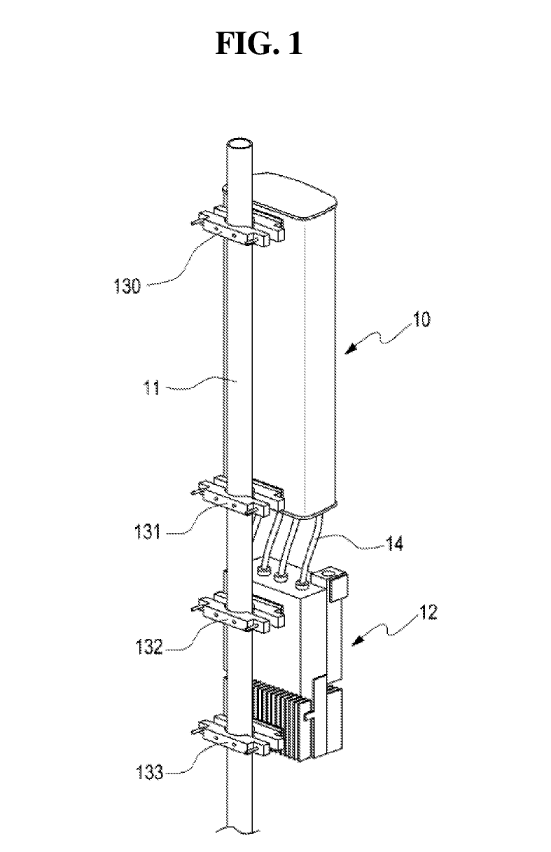

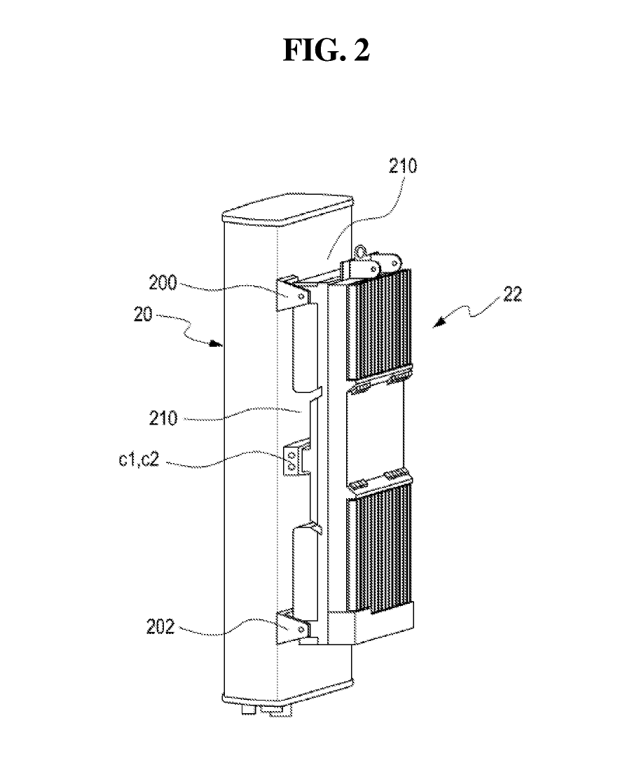

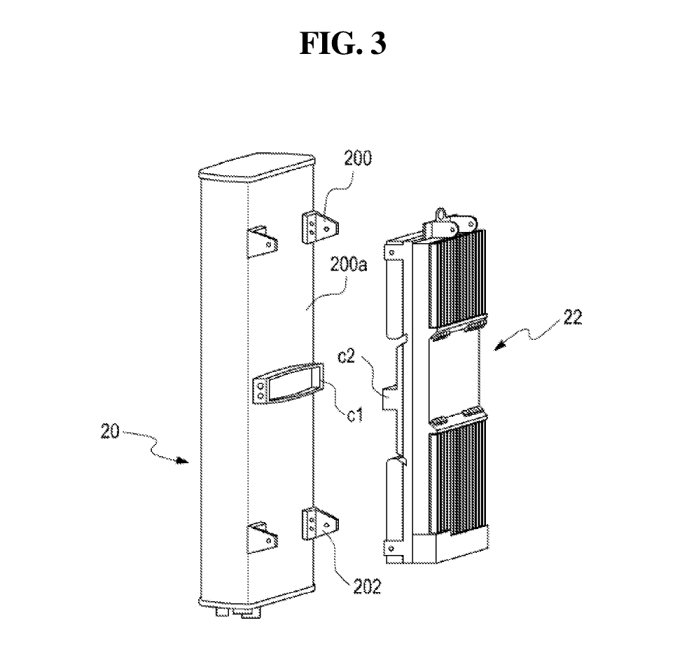

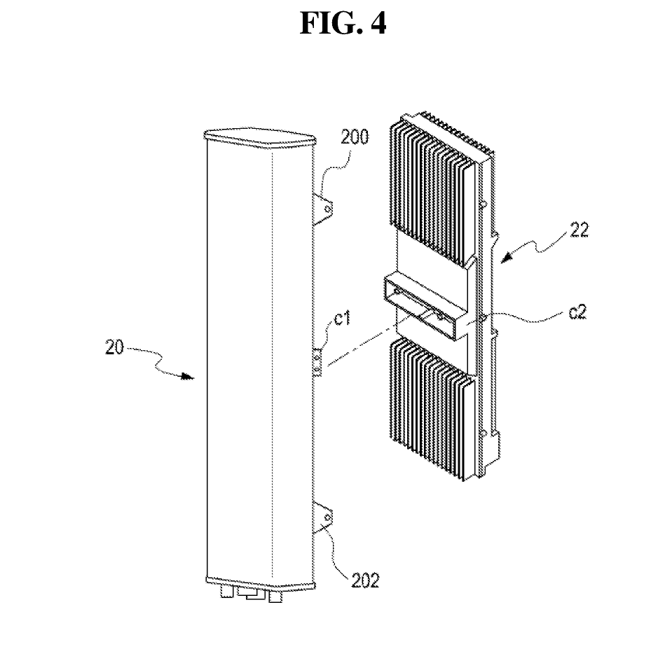

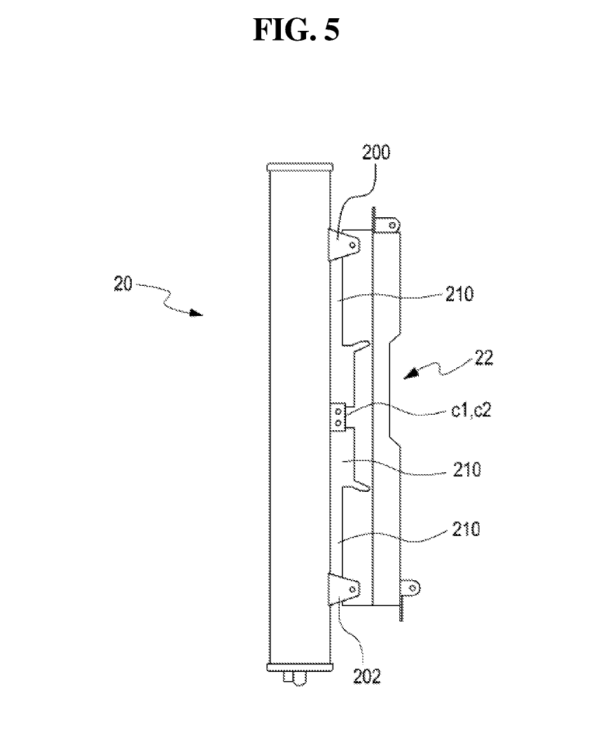

Referring to FIGS. 1 to 8, a configuration of an antenna unit for a base station according to a first embodiment of the present disclosure will be described. An antenna module 20 described in the present embodiment refers to an antenna module having at least one frequency band. Further, a repeater described in the present embodiment, which is a Remote Radio Head (RRH) (hereinafter, referred to as “RRH”), refers to an antenna and base station transmission/reception apparatus connected to an antenna for each frequency band provided to the antenna module 20. The RRH refers to repeater equipment having a function of receiving a weakened signal between a base station and a mobile communication terminal of a mobile communication system to amplify the weakened signal, retransmit a signal, adaptively shape a distorted waveform, readjust timing, or the like.

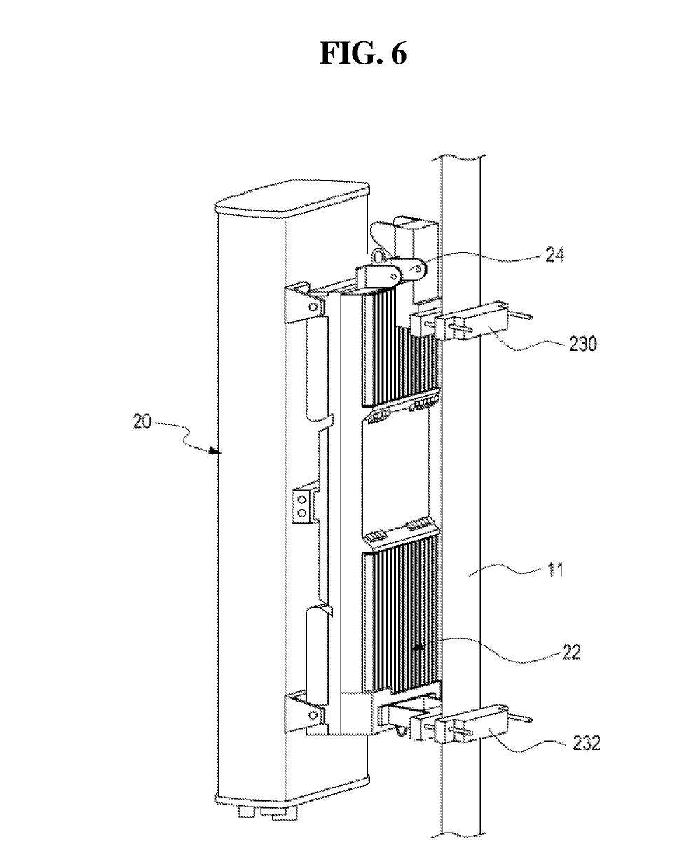

In the antenna unit according to the present embodiment, the antenna module 20 and the RRH 22 are installed in an uprightly standing support 11 (illustrated in FIG. 6). As compared with the related art (the antenna module and the RRH are arranged on upper and lower sides along the vertical direction of the support, respectively), the RRH 22 is arranged to face the bottom surface 200a from among the outer surfaces of the antenna module 20, and is then directly coupled to the antenna module 20. The RRH 22 is spaced apart from the bottom surface 200a of the antenna module and mounted to the bottom surface 200a with a constant interval. Approximately, the antenna module 20 and the RRH 22 are arranged to be parallel to each other. Hereinafter, an open space between the antenna module 20 and the RRH 22 is referred to as a cooling air gap 210.

One or more RRHs 22 according to the present embodiment may be coupled to each other along the lengthwise direction of the outer surface of the antenna module 20 and may be configured to be longer and slimmer, as compared with the conventional RRH 12 (illustrated in FIG. 1). As described below, the RRH 22 is configured longer and slimmer than the conventional RRH 12, and thus, is effective to improve a heat dissipation function.

The antenna unit according to the present embodiment may include the antenna module 20 mounted to the uprightly standing support 11; the RRH 22 arranged to face the antenna module 20, and a plurality of cooling air gaps 210 located between the antenna module 20 and the RRH 22. The RRH 22 is arranged to face the outer surface of the antenna module 20 at a constant interval. At this time, the RRH 22 and the antenna module 20 are arranged to face each other in a face-to-face manner. Although it will be described later, the antenna module 20 and the RRH 22 are directly connected to each other by a connection part. At the same time, a connection structure combines a fixing structure.

The antenna module 20 may be an antenna which can perform a 3G mobile communication service or a 4G mobile communication service. The antenna module 20 has an approximately long shape and the upper surface and the lower surface thereof from among a plurality of outer surfaces are closed by a separate cover. Further, for the direct coupling and connection with the RRH 22, fixing structures 200 and 202 are arranged at upper and lower ends of the bottom surface 200a, respectively, and single connection parts c1 and c2 are arranged at the center of the bottom surface 200a. Correspondingly, a heat sink 220 is provided on the outer surface of the RRH 22, and the single connection parts c1 and c2 are arranged at the center of the outer surface facing the bottom surface 200a of the antenna module 20. The antenna module 20 and the RRH 22 are electrically and mechanically connected to each other by direct coupling between the respective connection parts c1 and c2. The respective single connection parts c1 and c2 protrude to face each other, and are coupled to each other in a male and female form.

The RRH 22 is configured in a long shape, which is similar to the antenna module 20. Since the RRH 22 is mounted along the lengthwise direction of the antenna module 20, it is preferred that the RRH 22 is configured in a long shape, which is similar to the antenna module 20.

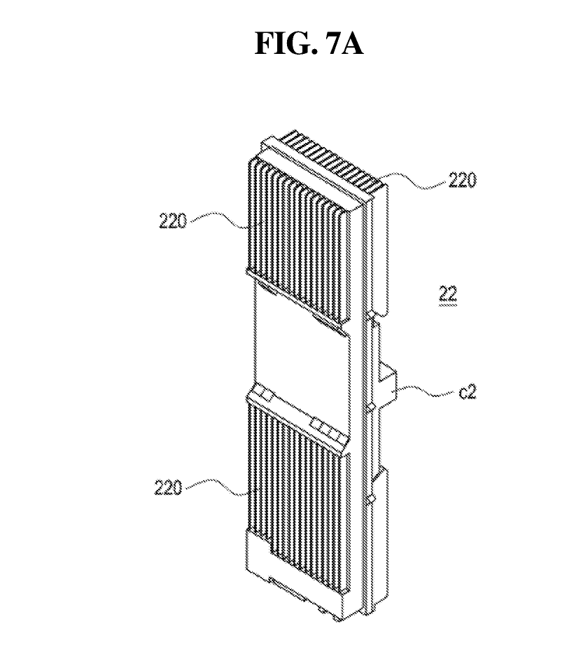

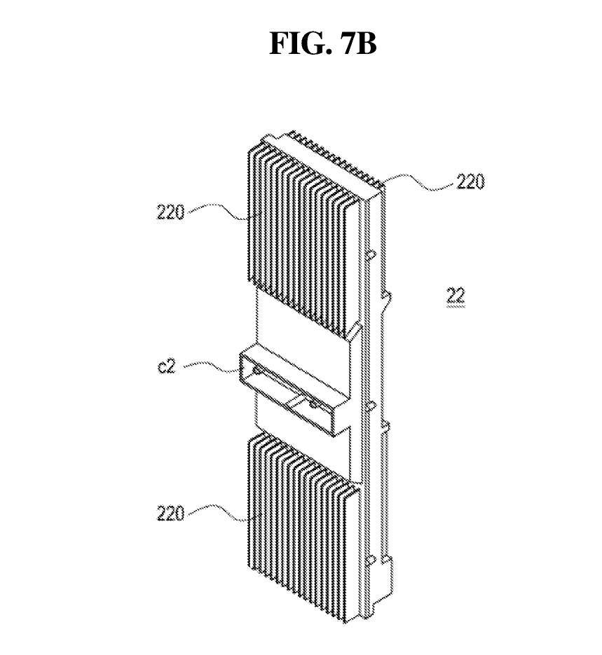

The cooling air gap 210 is an open space existing as the antenna module 20 and the RRH 22 are coupled to each other with a constant interval, and is in charge of a heat dissipation function. Since the outer surface of the RRH 22 should perform a heat dissipation function, heat sinks 220 (illustrated in FIGS. 7A and 7B) such as a cooling pin are provided on the upper surface and the lower surface. The cooling air gaps 210 communicate with the outside in a left or right direction or an upper or lower direction, thereby achieving ventilation in various directions, and helping the heat dissipation function of the RRH 22. The cooling air gaps are located on left and right sides of the RRH 22, and the cooling air gaps are located in the upper and lower fixing structures 200 and 202 in a vertical direction.

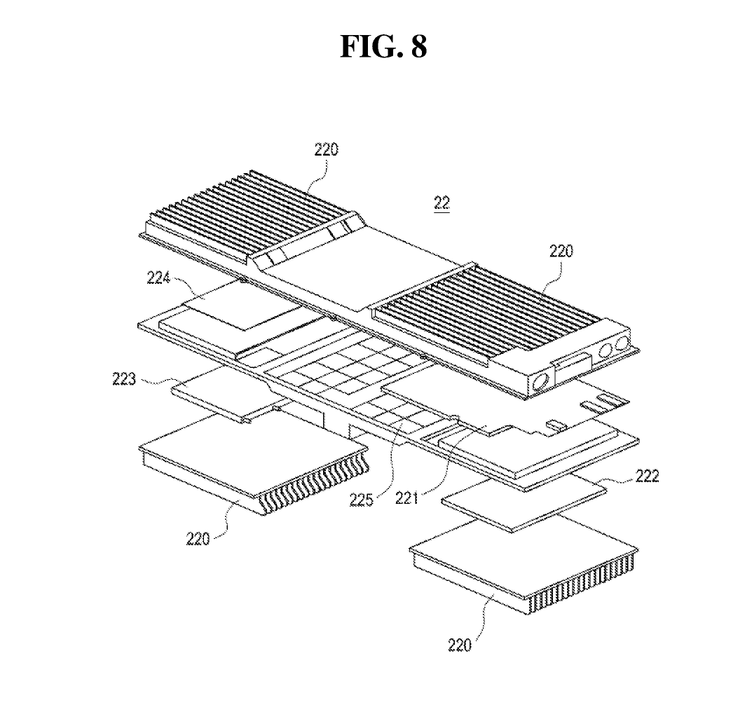

Referring to FIG. 8, an internal configuration of the RRH 22 will be described. In connection with describing the internal configuration of the RRH 22, only a main component related to the present embodiment will be described. As compared with the conventional RRH 12, the RRH 22 according to the present embodiment may be configured in a longer and slimmer shape. Thus, a plurality of internal components of the RRH 22 may be distributedly arranged along the lengthwise direction. For example, power amplification units 222 and 223 provided within a housing of the RRH 22 emit the largest heat, and thus, are separated in two parts, and are distributedly arranged, so that the heat emission is minimized. Although described already, since the RRH 22 can be configured to be longer and slimmer as compared with the related art, the heat sink 220 can be also arranged to be wider as compared with the related art.

The RRH 22 may include a board 221, two Power Amplifying Units (PAUs) 222 and 223, a Power Supplying Unit (PSU), and a plurality of heat sinks 220. The PAUs 222 and 223 are arranged along the lengthwise direction of the RRH 22, and are substantially arranged on both sides of the board 221. Since heat generated by one PAU having an area obtained by summing areas of the two PAUs 222 and 223 is smaller than heat generated by the respective PAUs 222 and 223, it is advantageous that two or more PAUs 222 and 223 are configured in consideration of a heat dissipation effect. The PSU 224 is arranged parallel to the board 221 substantially along the lengthwise direction, and is arranged vertically parallel to one PAU 223. Reference numeral 225 is referred to as a front end unit.

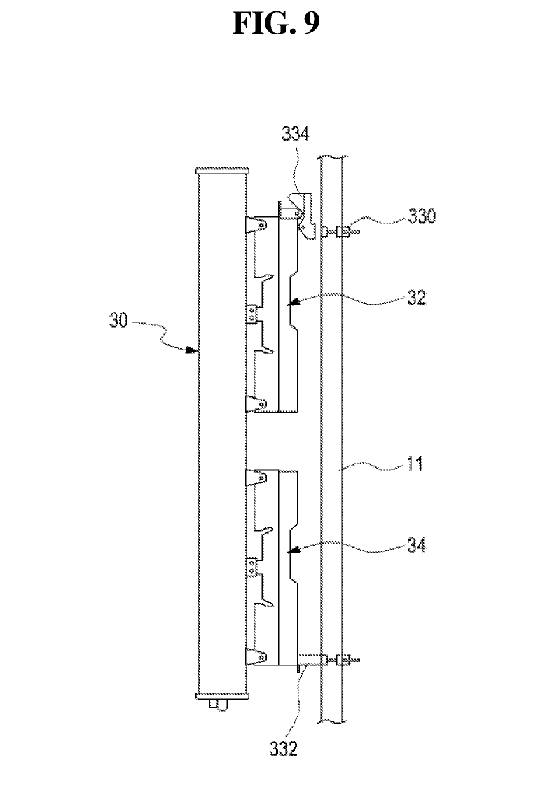

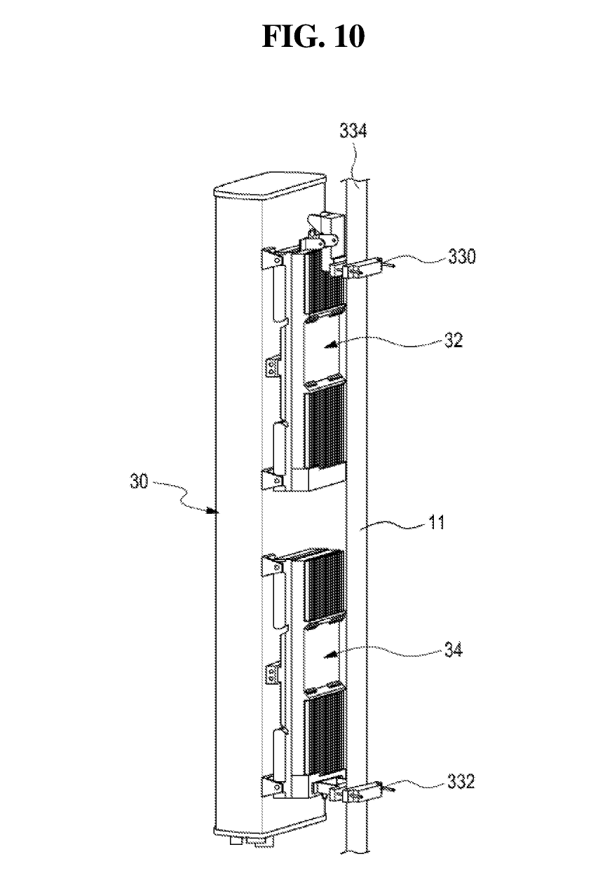

FIG. 9 is a side view illustrating a state in which an antenna unit is mounted to a support 11 according to another embodiment of the present disclosure. FIG. 10 is a perspective view illustrating a state in which an antenna unit is mounted to a support 11 according to another embodiment of the present disclosure. Referring to FIGS. 9 and 10, in connection with an antenna unit according to the present embodiment, two RRHs 32 and 34 may be arranged in an antenna module 30 along the lengthwise direction of the antenna module 30 side by side. At this time, in order to mount an antenna unit to the support 11, two fixing brackets 330 and 332 are adopted and a slope adjustment bracket 334 is adopted. From among the two brackets, one fixing bracket 330 is fixed to the support 11 while being mounted to an upper end of one RRH 32, and the other fixing bracket 332 is fixed to the support 11 while being mounted to a lower end of the other one RRH 34. The external and internal configurations of the respective RRHs 32 and 34 have the same configuration, and the description therefor will be omitted because it has been written already. In addition, the antenna unit may be configured while three or more RRHs are arranged in the antenna module 30.

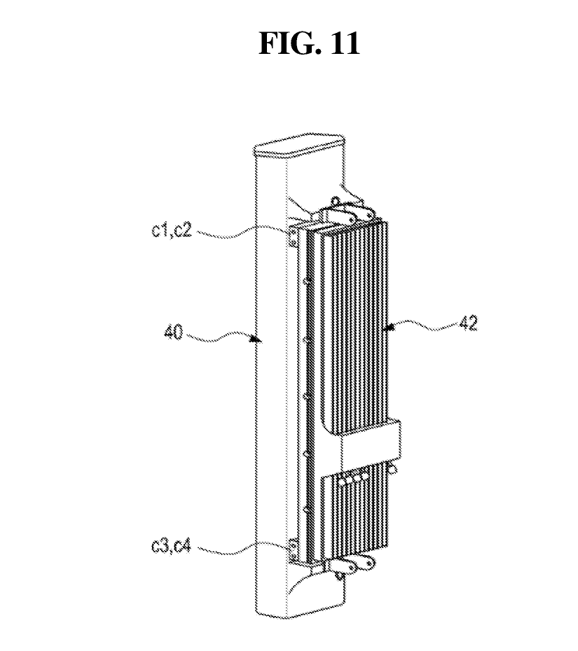

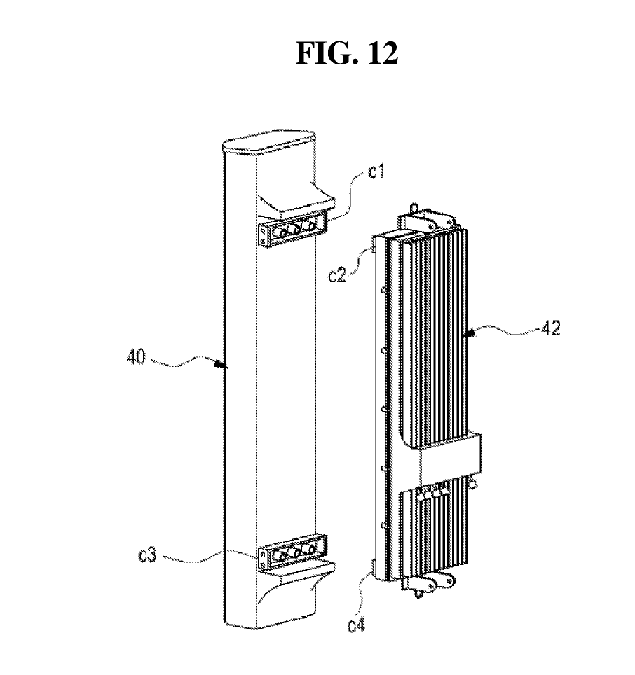

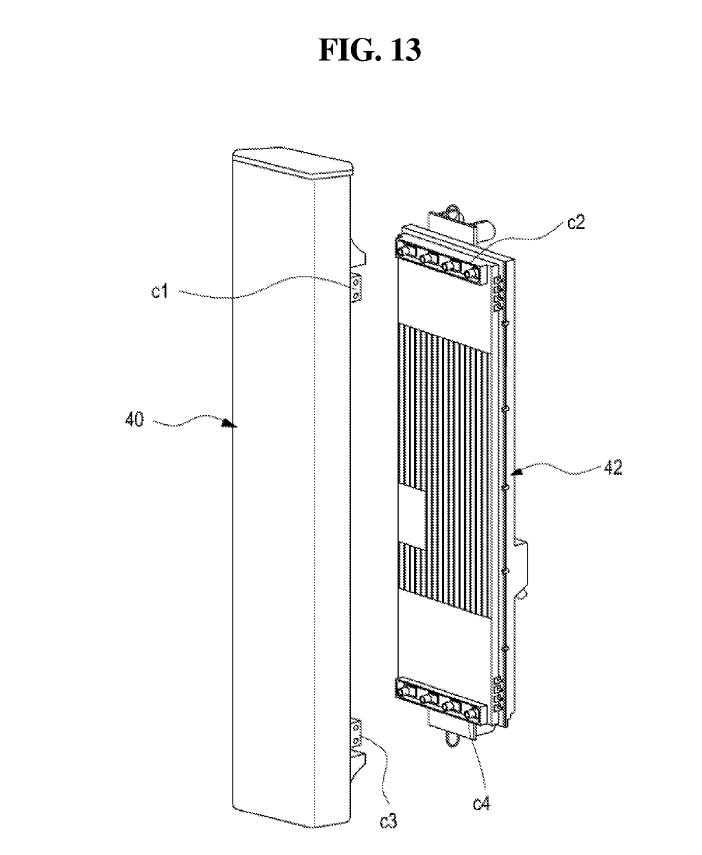

Hereinafter, an antenna unit according to yet another embodiment will be described with reference to FIGS. 11 to 17.

As illustrated in FIGS. 11 to 17, the antenna unit according to the present embodiment has the same configuration as the antenna unit illustrated in FIGS. 1 to 8 except that there are two connection parts c1 and c2; c3 and c4 and internal components of the RRH 42 are differently arranged. Thus, only the difference will be described, and the description for the same configuration will be omitted. The difference is the number of the connection parts and arrangement of the internal main components. The antenna unit illustrated in FIGS. 1 to 8 has one connection part arranged at the central point. However, in the present embodiment, the connection parts c1, c2; and c3, c4 are arranged at upper and lower ends so that a coupling and fixing force between the antenna module 40 and the RRH 42 is doubled, thereby achieving a stable coupling state, and more connection terminals may be provided according to an increase in the number of connection parts.

In the antenna unit according to the present embodiment, two connection parts for connecting the antenna module 40 and the RRH 42 to each other are provided. In order to electrically/mechanically connect the antenna module and the RRH to each other, the first and second connection parts c1, c2; and c3, c4 are provided at upper and lower ends. The first connection part may include one connection part c1 at an upper end of the bottom surface of the antenna module 40 and one connection part c2 at an upper end of a corresponding surface of the RRH 42. The second connection part may include one connection part c3 at a lower end of the bottom surface of the antenna module 40 and one connection part c4 at a lower end of a corresponding surface of the RRH 42. A fixing force between the antenna module 40 and the RRH 42 is vertically distributed by the first and second connection parts c1, c2; c3, c4, thereby achieving more stable coupling and connection between the antenna module 40 and the RRH 42.

The respective connection parts c1, c2; and c3, c4 may be formed in a form of a male and female connector. The first connection parts c1 and c2 protrude to face each other, and are inserted into and connected to each other. The second connection parts c3 and c4 protrude to face each other, and are inserted and connected to each other.

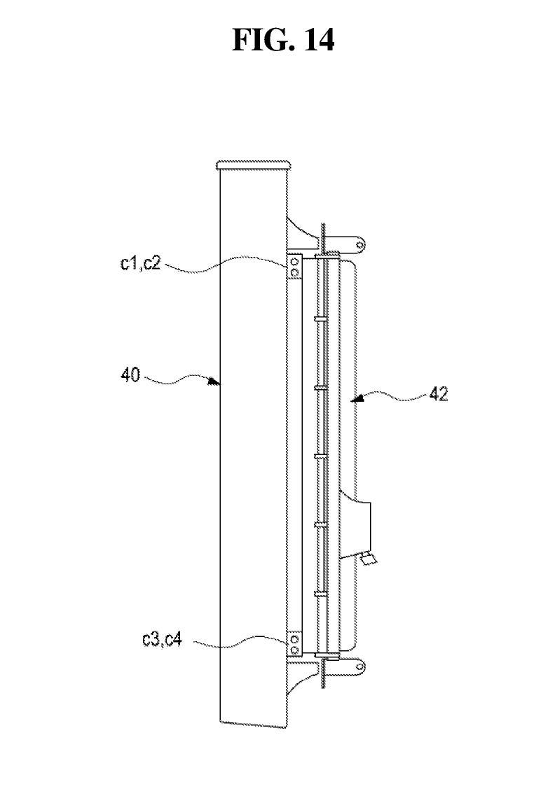

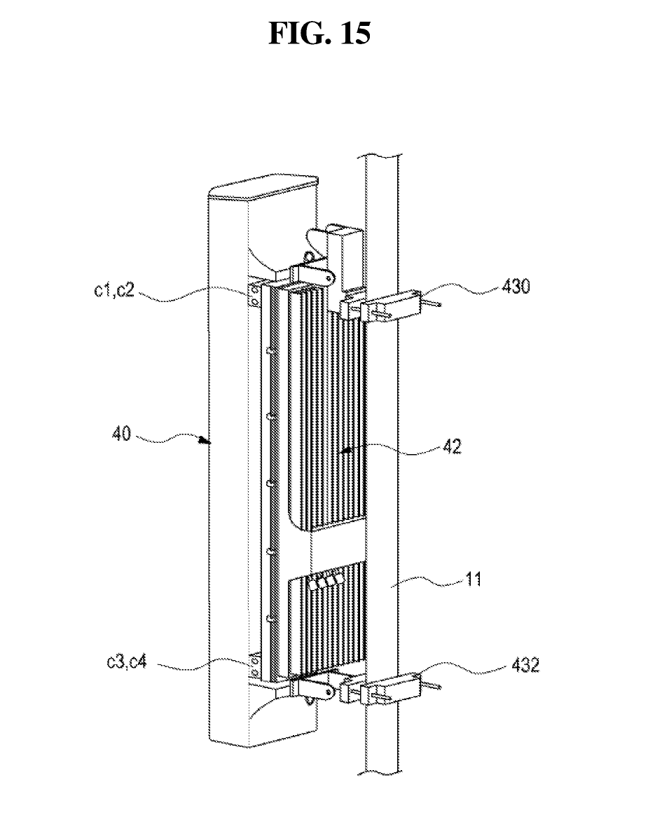

As illustrated in FIGS. 14 and 15, the antenna unit according to the present embodiment is mounted to a support 11 by using two fixing brackets 430 and 432 and one slope angle to adjustment bracket 434.

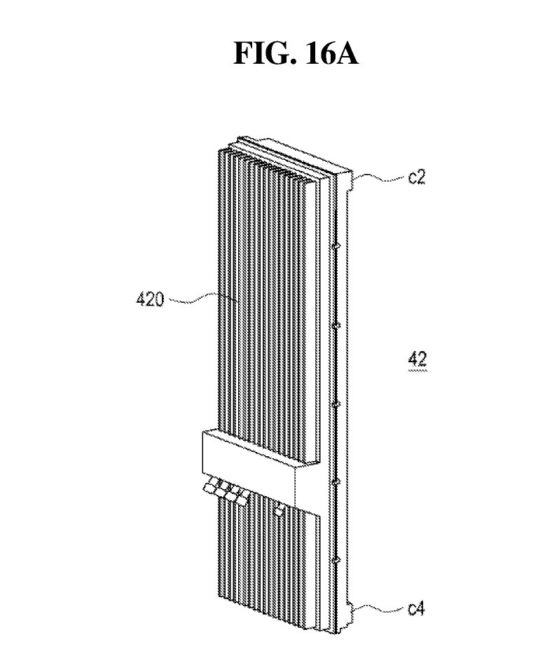

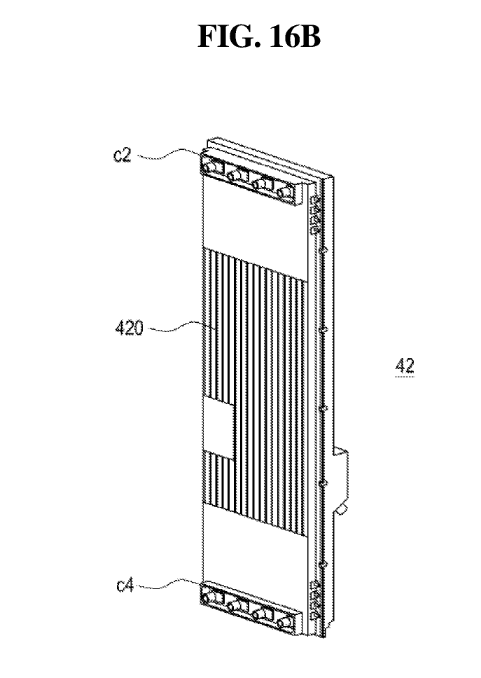

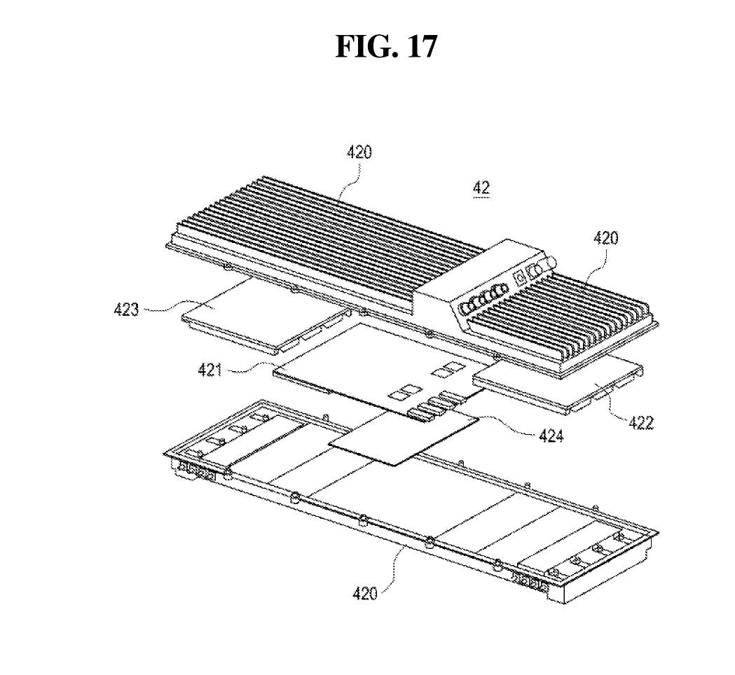

Hereinafter, an internal configuration of the RRH 42 will be described with reference to FIGS. 16A to 17. In connection with describing the internal configuration of the RRH 42, only a main component related to the present embodiment will be described. As compared with the conventional RRH 12, the RRH 42 according to the present embodiment may be configured in a longer and slimmer shape. Thus, the internal components of the RRH 42 can be distributedly arranged along the lengthwise direction. For example, PAUs 422 and 423 provided within a housing of the RRH 42 emit the largest heat, and thus, are separated in two parts, and are widely and distributedly arranged, so that the heat emission is minimized efficiently. Although described already, since the RRH 42 can be configured to be longer and slimmer as compared with the related art, the heat sink 420 can be also arranged on the outer surface of the RRH 42 to be wider as compared with the related art.

The RRH 42 includes a board 421, two PAUs 422 and 423, a PSU 424, and a plurality of heat sinks 420 arranged on the outer surface. The PAUs 422 and 423 are arranged along the lengthwise direction of the RRH 42, and are arranged in parallel on both sides of the board 221. Since heat generated by one PAU obtained by summing the two PAUs is smaller than heat generated by the respective separated PAUs 222 and 223, it is advantageous that two PAUs 422 and 423 are configured in consideration of a heat dissipation effect. The PSU 422 is arranged in parallel to substantially face the board 421. Although it has been exemplified that one board 421 according to the present embodiment is adopted, two or more boards can be configured because a large amount of heat is generated by the board. In conclusion, from among the internal main components constituting the RRH, each of components emitting a relatively large amount of heat may be configured into two or more parts, which are then distributedly arranged to prevent performance degradation by heat. Further, such a distributed arrangement is good for improving the antenna characteristics of a base station.

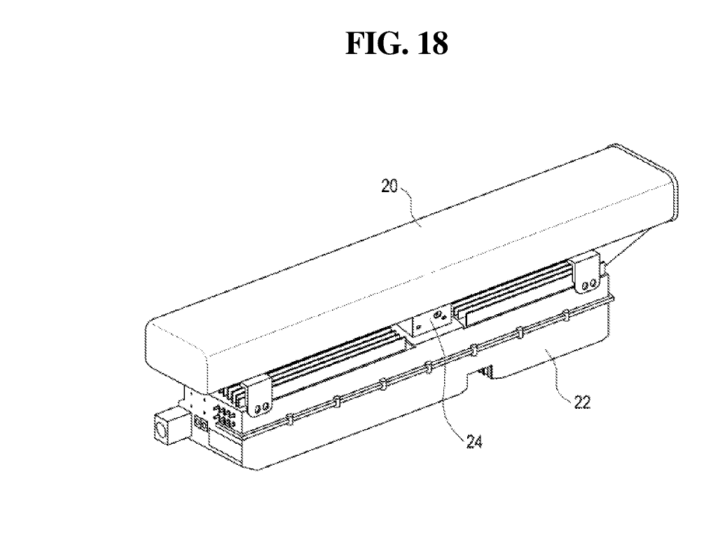

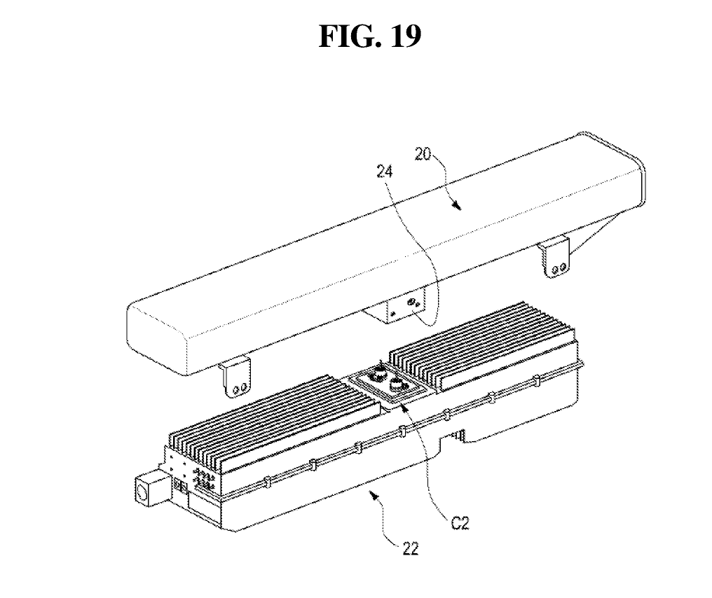

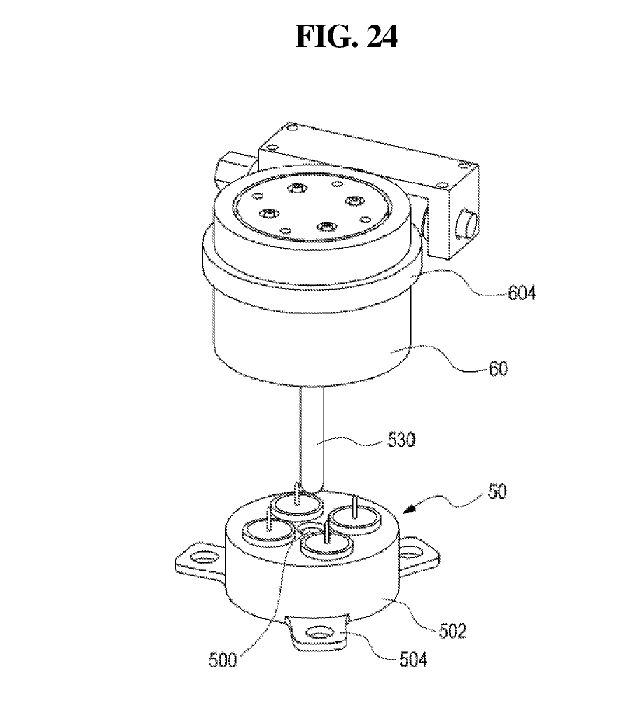

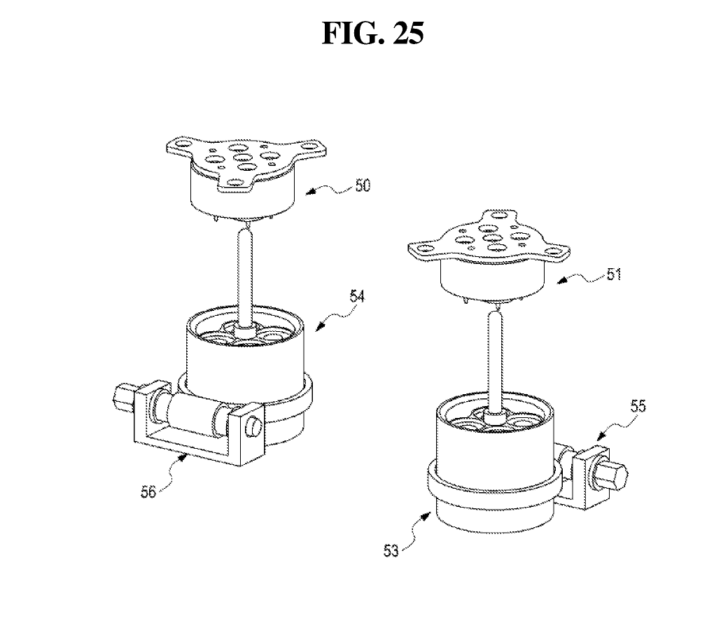

Hereinafter, an antenna unit according to yet another embodiment will be described with reference to FIGS. 18 to 25. The antenna unit includes a structure in which an electrical connection state between the antenna module 20 and the RRH 22 can be stably and firmly maintained for a long time. Although will be described later, the above-described structure implies an apparatus which is hidden in a connection housing 24, but can stably maintain a connection state by a simple rotating operation from the outside.

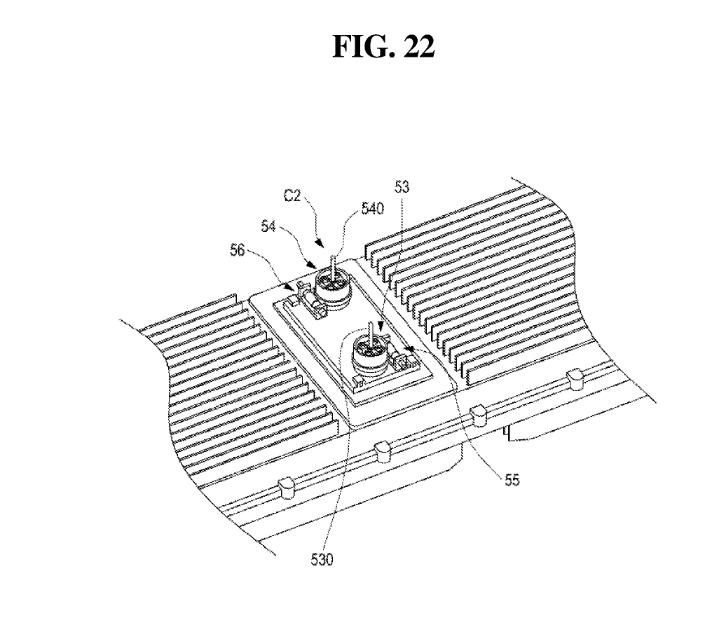

As illustrated in FIGS. 18 to 20, the antenna unit is formed as one body by connecting and coupling the antenna module 20 and the RRH 22. The connection and coupling structure includes at least one connection part C1 and C2 arranged within the connection housing 24 and rotating operation parts 55 and 56 (illustrated in FIG. 22) for firmly maintaining a connection state of the connection part C1 and C2 or adjusting the connection state from the outside.

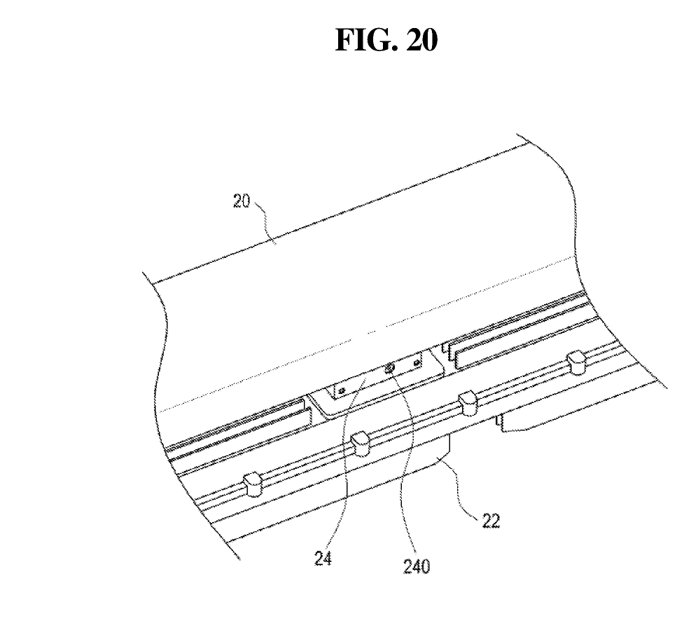

FIG. 20 illustrates an opening 240 formed on one surface of the connection housing 24. The opening 240 enables the rotating operation parts 55 and 56 (illustrated in FIG. 22) arranged inside the structure to be operated from the outside. Although will be described later, a head part of a second gear part is exposed through the opening, so that the rotating operation parts 55 and 56 come into a rotation-operable state.

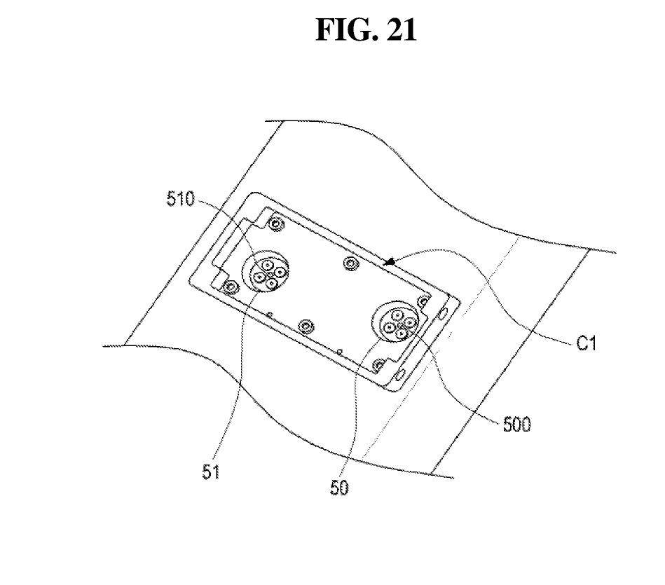

FIG. 21 is a perspective view illustrating an antenna connection part C1 provided in the antenna module 20. FIG. 22 is a perspective view illustrating an RRH connection part C2 provided in the RRH 22.

The antenna connection part C1 includes first and second antenna connection parts 50 and 51. Each of the first and second antenna connection parts 50 and 51 includes four connection terminals. The four connection terminals are arranged in a vertically and horizontally symmetric shape. The four connection terminals are formed to be stepped from the remaining bottom surface. Further, the first and second antenna connection parts 50 and 51 have first and second guide holes 500 and 510 at the centers thereof, respectively. While first and second guide pins which will be described below are inserted into the first and second guide holes 500 and 510, the first and second guide holes 500 and 510 serve to guide a mutual connection and coupling location.

The RRH connection part C2 includes first and second RRH connection parts 53 and 54. Each of the first and second RRH connection parts 53 and 54 includes four connection terminals. The four connection terminals are arranged in a vertically and horizontally symmetric shape. Further, the first and second RRH connection parts 53 and 54 have first and second guide pins 530 and 540 at the centers thereof, respectively. While being inserted into the first and second guide holes 500 and 510, the first and second guide pins 530 and 540 serve to guide the connection and coupling location.

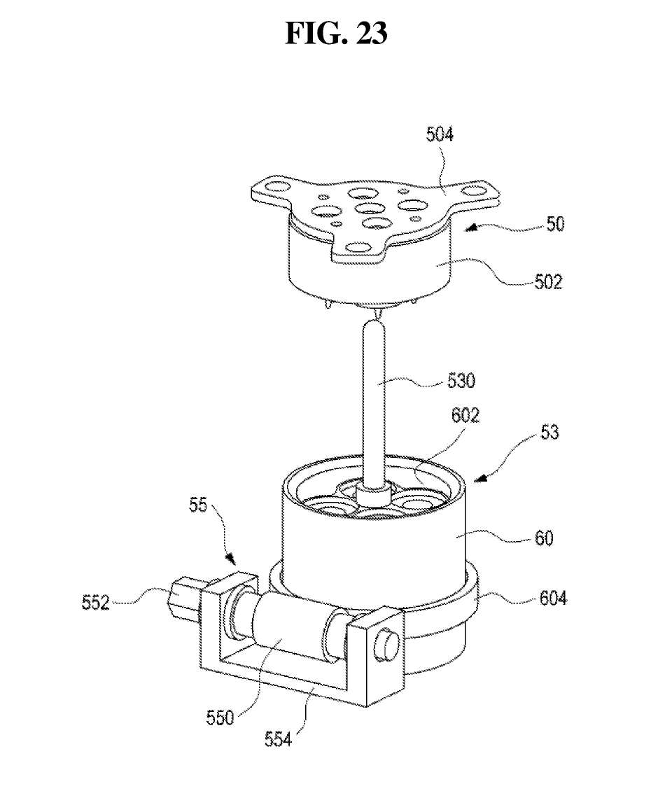

Further, first and second rotating operation parts 55 and 56 are mounted to the first and second RRH connection parts 53 and 54, respectively. Hereinafter, configurations of the first and second rotating operation parts will be described with reference to FIGS. 23 to 25.

As illustrated in FIGS. 23 to 25, since the first and second rotating operation parts 55 and 56 have the same configuration, only a configuration of the first rotating operation part 55 will be described. However, the first and second rotating operation parts 55 and 56 are not symmetrically mounted. The first rotating operation part 55 is arranged on a lower side of the first RRH connection part 53 in parallel and the second rotating operation part 56 is mounted to an upper side of the second RRH connection part 54. FIG. 22 illustrates an arrangement state of the first and second rotating operation parts 55 and 56.

The first rotating operation part 55 operates according to a rotating operation from the outside, and adjusts a connection state between the antenna connection part and the RRH connection part. The first rotating operation part 55 includes first and second screw parts 502 and 602, a coupling nut 60, and first and second gear parts 604 and 550. The first screw part 502 is entirely arranged on the outer peripheral surface of the antenna connection part 50. The second screw part 602 is arranged at the cylindrical outer periphery of the RRH connection part 53, and is entirely formed on the inner surface of the coupling nut 60. According to the rotation of the coupling nut 60, the first screw part 502 is screw-inserted into the second screw part 602 so as to adjust the connection state. When the coupling nut 60 is rotated, the antenna connection part and the RRH connection part move to get farther away from each other or get closer to each other. Preferably, the first screw part 502 is preferably made of an injection-molding material, and the coupling nut 60 is preferably made of a light metal material That is, the first screw part 602 and the first gear part 604 can be made of a light metal material. The connection state between the antenna connection part and the RRH connection part can be configured in a ground coupling state between terminals of both connection parts by the coupling nut. As mentioned, the terminals of the antenna connection parts are configured in a stepped shape, and the RRH is configured in a shape corresponding to the terminals Thus, when the connection parts are connected to each other, areas other than the terminals come into contact with each other, so that a ground coupling state is configured.

It has been described that the gear parts include the first and second gear parts 604 and 550 as a power transmission part. The first gear part 604 is mounted on the outer peripheral surface of the coupling nut 60, and the second gear part 550 is arranged to be engaged with the first gear part 604 and to be perpendicular to the connection direction. The first gear part 604 is a general gear having gear teeth, and the second gear part 550 is a general worm gear. When the second gear part 550 is rotated, the first gear part 604 is rotated. However, the first and second gear parts 604 and 550 have different axes of rotation, which are perpendicular to each other. When the second gear part 550 is rotated, the first gear part 604 engaged with the second gear part 550 is rotated, and the coupling nut 60 is simultaneously rotated, so that the antenna connection part moves along the connection direction, thereby more stably adjusting the connection state.

The second gear part 550 has a head part 552 formed at a rotary shaft end. The head part 552 is arranged to be exposed to the outside through the opening, so that the second gear part 550 can be operated from the outside. The head part 552 has a shape of a hexagonal column, but is not limited to the shape of a hexagonal column, and may be configured in a shape of a square column or a pentagonal column.

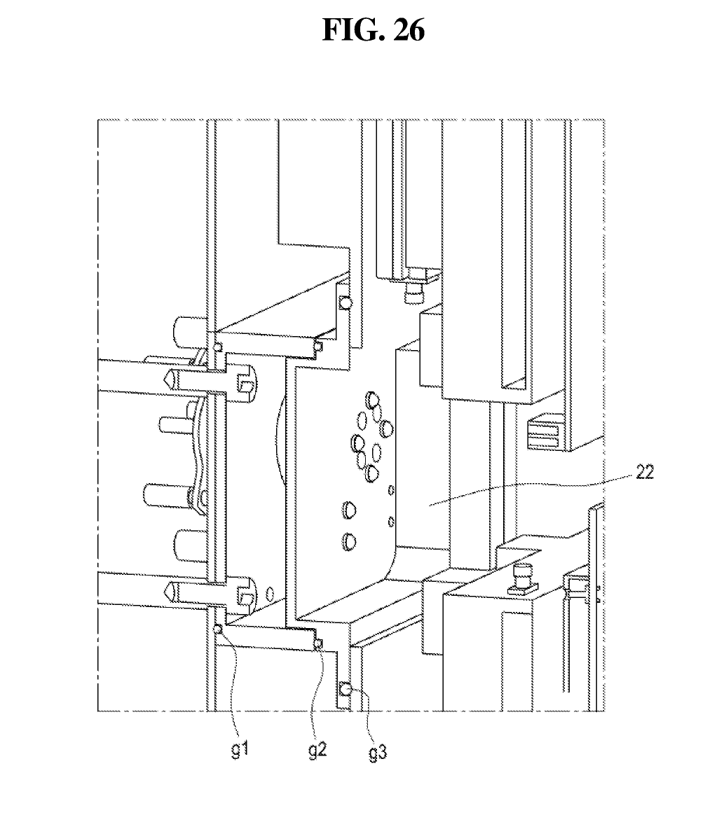

Referring to FIG. 26, the RRH 22 has a plurality of gaskets g1, g2 and g3 therein, which provide a waterproofing structure. The gaskets g1, g2 and g3 may be made of a highly elastic rubber or sealant, a silicon material, or the like. Each of the gaskets g1, g2 and g3 is installed in a part of the internal coupling structure of the RRH, when a gap may be generated, and prevents external environments, e.g., water, moisture, foreign substances, or the like from penetrating into the interior of the antenna unit. In addition, the waterproofing structure can be implemented using a waterproofing tape instead of the gaskets g1, g2 and g3. In order to maximize a waterproofing function of the gaskets, a small groove on which each of the gaskets g1, g2 and g3 is seated may be configured.

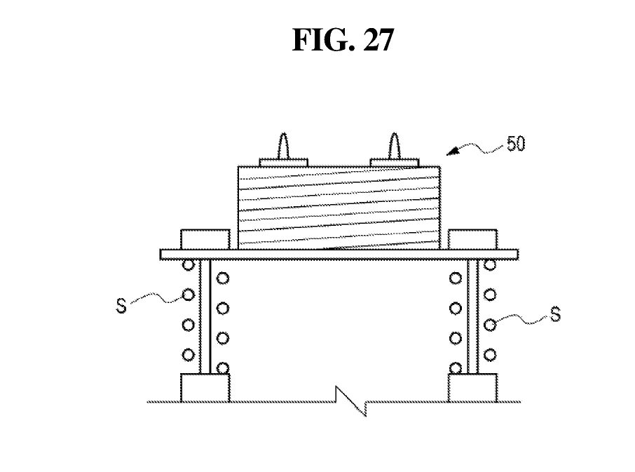

Referring to FIG. 27, the antenna connection part 50 is mounted to the antenna module while being supported by an elastic body s. The antenna connection part 50 is mounted to move three-dimensionally and minutely, and the three-dimensional and minute movement is for stably supporting the connection state between the antenna connection part 50 and the RRH connection part. In particular, the three-dimensional and minute movement serves to prevent an excessive coupling state between the antenna connection part 50 and the RRH connection part, and maintains a firm connection state for a long time. Another antenna connection part 51 (illustrated in FIG. 21) has the same configuration. The elastic body s may be configured as a coil spring.

As described above, in an antenna unit for a base station according to various embodiments of the present disclosure, fixing components used for installing an antenna module and a repeater in a support are minimized, so that installation costs of the antenna unit are minimized and maintenance thereof becomes easy. Further, a cable for connecting the antenna module and the repeater is not used, so that while installation costs are minimized, an RF transmission loss of an antenna is minimized, thereby contributing to improvement of antenna performance characteristics, and improvement of energy efficiency.

Further, in an antenna unit according to various embodiments of the present disclosure, an RRH is arranged on the bottom surface of an antenna module mounted to a support, so that an installation space of the antenna unit is minimized, and thus, costs of a rental space of the antenna unit is minimized, thereby achieving an economical advantage.

Further, an antenna unit according to various embodiments of the present disclosure has a structure advantageous in heat dissipation, in which a long and slim RRH is employed so that it is possible to distributedly arrange internal main components, which emit a large amount of heat.

Further, in an antenna unit for a base station according to various embodiments of the present disclosure, a firm connection state between connection parts can be adjusted by simple rotation manipulation from the outside, so that the firm connection state between the connection parts can be maintained. In particular, even while the connection state is adjusted from the outside, water, moisture or foreign substances can be prevented from entering the antenna unit. Additionally, in a connection structure of the present invention, ground coupling between connection terminals is possible.

Although the present invention is shown and described with reference to the specific embodiments, it will be understood by a person skilled in the art that the details and forms of the present invention may be modified in various forms without departing from the spirit and the scope of the present invention as defined by the attached claims and the equivalents thereof.

What is claimed is:

1. An antenna unit for a base station, the antenna unit comprising:
an antenna module; and
at least one Radio Remote Head (RRH) arranged to face an outer surface of the antenna module, coupled to the antenna module through direct connection, and arranged along the lengthwise direction of the antenna module,
wherein a plurality of cooling air gaps are provided between the outer surface of the antenna module and the RRH.

2. The antenna unit of claim 1, wherein the cooling air gaps comprise a space between the outer surface of the antenna module and the RRH arranged to be spaced apart from the outer surface.

3. The antenna unit of claim 2, wherein the cooling air gaps have a structure communicating with upper/lower/left/right sides.

4. The antenna unit of claim 1, wherein the antenna module and the RRH have single connection parts, which face each other and protrude from centers of the antenna module and the RRH, respectively, so that the antenna module and the RRH are connected to each other through mutual direct connection.

5. The antenna unit of claim 4, wherein the antenna module and the RRH have fixing structures formed at upper and lower ends of the antenna module and the RRH, respectively, and the fixing structures have the cooling air gaps, respectively.

6. The antenna unit of claim 1, wherein the antenna module and the RRH have first connection parts facing each other and protruding from upper ends of the antenna module and the RRH, and second connection parts facing each other and protruding from lower ends of the antenna module and the RRH, the antenna module and the RRH are connected to each other through mutual direct connection, and for the connection, fixing structures are provided at the upper and lower ends.

7. The antenna unit of claim 6, wherein a lower surface of the antenna module is manufactured integrally with an external housing, and has a blocked structure.

8. The antenna unit of claim 2, wherein the RRH comprises:
a board;
a pair of power amplifying units arranged in parallel on both sides of the board along a lengthwise direction of the RRH; and
a power supply unit arranged in parallel to the board.

9. An antenna unit for a base station, the antenna unit comprising:
an antenna module;
at least one RRH arranged to face an outer surface of the antenna module, and arranged along a lengthwise direction of the antenna module; and
connection parts formed in the antenna module and the RRH, respectively, and arranged to be hidden in an interior of the antenna unit by a connection housing,
wherein the connection parts comprises:
at least one antenna connection part mounted to the antenna module;
at least one RRH connection part coupled to the RRH and connected to the antenna connection part, respectively;
the connection housing formed integrally with the antenna module;
at least one opening that is formed in the connection housing and allows operation from the outside; and
at least one rotating operation part which is arranged in the connection housing, is arranged to be operable by the opening, and fixes a connection state of the connection parts.

10. The antenna unit of claim 9, wherein the rotating operation parts comprise:
a first screw part mounted on an outer peripheral surface of the antenna connection part;
a coupling nut which is arranged on an outer periphery of the RRH connection part, comprises a second screw part screw-inserted into the first screw part, and fixes the connection state by the screw-insertion between the first and second screw parts; and
a power transmission part comprising first gears mounted on an outer peripheral surface of the coupling nut, and a second gear part arranged to be engaged with the first gears, arranged perpendicular to a direction of connection, and rotating to rotate the coupling nut.

11. The antenna unit of claim 10, wherein the second gear part comprises a head part arranged to be exposed to the outside through the opening and enabling a rotating operation from the outside.

12. The antenna unit of claim 9, wherein the RRH connection part further comprises a guide pin linearly extending from a center to the direction of connection so as to guide a coupling location, and the antenna connection part further comprises a guide hole into which the guide pin is inserted.

13. The antenna unit of claim 9, wherein the antenna connection unit is mounted to the antenna module while being supported by an elastic body to move three-dimensionally.
